(19) United States
(12) Patent Application Publication
(10) Pub. No.: US 2009/0197689 A1
(43) Pub. Date: Aug. 6, 2009

(54) Protection device, in particular power take- off shaft protection, for an end piece of a shaft

(76) Inventor: Franz Sauermann, Schrobenhausen (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/354,570

(22) Filed: Jan. 15, 2009

(30) Foreign Application Priority Data
Jan. 15, 2008 (DE) 10 2008 000 064.7

(51) Int. Cl. F16D 3/84

(52) U.S. Cl. 464/176

(57) ABSTRACT

The present invention relates to a protection device for an end piece of a shaft, in particular a power take-off shaft protection for a work machine. The protection device comprises a cover which is pivotally mounted to a base member, wherein both the cover and the base member are made of plastic material. Moreover, the cover is pivoting about a pivot axis from a home position with respect to the base member into various protective positions toward the work machine and away from the same. The respective protective positions are determined and stably held by a lock mechanism at the protection device.

### CROSS-REFERENCE TO RELATED APPLICATIONS

This application claims priority to German Patent Application DE 10 2008 000 064.7, filed on Jan. 15, 2008, the disclosure of which is incorporated herein by reference in its entirety.

### FIELD OF THE INVENTION

The invention relates to a protection device for an end piece of a shaft, in particular to a power take-off protection for a work machine (e.g. tractor).

### BACKGROUND OF THE INVENTION

Engine-driven shafts are employed in different working fields. It is important in this context to protect persons staying in the vicinity of the shaft (power take-off shaft) which protrudes beyond its bearing against any contact with such rotating shaft. This is especially applicable to work machines such as tractors in which such power take-off shafts serve for driving various mounted implements. Said mounted implements are, for instance, mowers, haymakers and the like. In the case of a tractor a power take-off shaft driven by its engine via the gear train can be disposed in the front section and/or in the rear section of the tractor. In order to couple the respective mounted implement to the tractor an operator attaches a universal-joint shaft arranged at the mounted implement to the power take-off shaft.

Not only in the coupled state but also when the universal-joint shaft is disconnected, the shaft end (the power take-off shaft end) must be protected against contact with the operating person when the engine is running. Otherwise the operating person could be injured. Moreover, it must be ensured that when the mounted implement is disconnected grass, dirt, trash or other substances are prevented from winding onto the possibly further rotating power take-off shaft end. Therefore the power take-off shaft end must not be freely accessible.

So far, different protection devices have been employed for the power take-off shaft ends at tractors. In a first known protection device a cylindrical or conical member fastened at the bearing of the power take-off shaft surrounds the power take-off shaft end. Said cylindrical or conical member is usually made of plastic material. In order to disconnect a mounted implement the operating person withdraws the universal-joint shaft of the mounted implement from the power take-off shaft of the tractor so that the latter is brought into a release position. Then a cup-shaped cap is attached to the shaft end as a protective member so that the power take-off shaft is in a protected position. The operating person occasionally forgets to attach the protective cap or the latter can get lost.

In a second known protection device the power take-off shaft end is covered by a U-shaped sheet component which is welded, screwed or the like to the tractor.

A third known protection device likewise includes the afore-mentioned U-shaped cover part of sheet metal and furthermore another sheet component which can be variably fixed at the cover part in lateral oblong slits formed in the cover part via a screw-and-nut-connection. It is thus possible by loosening and tightening the screwed connections that the cover part can adopt various pivoting positions and thus protective positions as regards the position of the further sheet component fixed at the tractor and of the power take-off shaft end.

When protective covers of sheet metal are used, however, the following drawbacks occur. Sheet metals usually have to be protected against corrosion, i.e. they have to be at least primed. Said primer can be easily damaged, however, by the common field of application of the power take-off shaft protection in the construction of agricultural and work machines. Moreover, the safety positions in the known power take-off shaft protection of sheet metal always have to be loosened and tightened again by means of the screw-and-nut connection, whereby the operator's assembling and/or adjusting work is increased. Furthermore, the sheet thickness cannot be reduced at will, because a tread protection and strength requirements to the metallic protection device for a power take-off shaft end in accordance with the known standard regulations have to be complied with in the field of tractors and agricultural machines. Consequently, a weight reduction of the metallic protection device according to prior art is only possible to a very small extent.

### SUMMARY OF THE INVENTION

Accordingly, it is an object of the present invention to provide a protection device as described in the beginning, in particular a power take-off shaft protection, for an end piece of a shaft which has low weight and permits easy handling.

The object of the invention is achieved by a protection device, in particular a power take-off shaft protection, for an end piece of a shaft according to claim 1.

Advantageous further modifications are defined in the subclaims.

In accordance with the invention, a protection device, in particular a power take-off protection for an end piece of a shaft (e.g. a power take-off end) including a cover is provided which is pivotally mounted to a base member. Both the cover and the base member are made of plastic material which ensures low weight of the protection device.

The cover preferably is a cover part consisting at least of two leg portions and a top plate connecting said leg portions. The cover part preferably can be formed in one piece and U-shaped and can be pivoting about a pivot axis arranged at the base member from a home position into various protective positions.

By the term “U-shaped” cover part a component part of plastic having two leg portions and a top plate connecting the two leg portions is understood. The shape of the leg portions may be rectangular, P-shaped, L-shaped etc. In accordance with the invention, it is exclusively required that the cover part is pivotally mounted to the work machine (e.g. tractor) so that the cover part surrounds the power take-off shaft end at the top and at the sides in different protective positions with respect to the base member. The cover part can be pivotally mounted to the base member through a pivot axis, one or more hinges, etc. which are fixed both at the cover part and at the base member. The cover part is preferably pivoted at an upper portion of the base member so that the cover part can be pivoted from a home position in the direction to and from the work machine.

Preferably, the base member is swivel-mounted by a pivot axis to the cover part so that the various protective positions can be adjusted about the pivot axis starting out from a home position. The pivot axis is especially located in a plane which is at right angles or perpendicular to the axis of the shaft. Consequently, the pivot axis is formed spaced apart from the axis of the shaft and is aligned perpendicularly to the axis of the shaft.

At least in a home position the cover part is preferably adjacent to the base member via a stop laterally formed at least one of the leg portions of the cover part. It is preferred that the stop at the one leg portion is facing the other leg portion of the cover part. It is further advantageous that a stop is formed at both leg portions in such manner that the respective stops of the leg portions are opposed in a mutually corresponding way.

The base member is preferably formed by side parts opposed to each other and interconnected by a front-side protective wall. By designing the base member in this way a receiving space open to the front is formed in which the end of the shaft is provided before, during and after a swivel operation of the cover part about the pivot axis.

In a preferred embodiment, at least one lock mechanism is formed at least one leg portion and a corresponding side part. The lock mechanism can preferably be configured such that at least one recess is formed in the side parts or leg portions and a detent projecting laterally inwardly from the leg portions of the cover part or the side parts of the base member can engage in said recess, whereby the respective protective positions of the protection device can be clearly determined. I.e. the cover part can be pivotally mounted to the front (away from the tractor) or to the rear (toward the tractor) until the lateral recesses engage by the detent in the leg portions or side parts, whereby an appropriate pivoted protective position of the cover part with respect to the base member is clearly defined and fixed but is also fixedly held. Thus it is no longer necessary, for instance, to additionally tighten a screwed adjusting mechanism in accordance with prior art.

In the case of the lock mechanism according to the invention, the detent is adapted to positively engage in the corresponding recess. As an alternative, the detent can be frictionally accommodated in a corresponding bulge in the side part in the appropriate protective positions so as to determine and to hold by force fit the respective swivel position of the cover part with respect to the base member. Alternatively, it is also possible that the lock mechanism can ensure the respective protective position only by a frictional connection with the external surface of the side part without separate recesses being provided in the side part.

Furthermore, in a protective position in which the cover part is pivoted away from the base member and from the tractor, respectively, the detent can serve as a second stop so that in this protective position the second stop abuts on the front end face of the respective side part of the base member, thereby the position of the cover part with respect to the base member being determined and stably held.

The recesses are preferably in the form of oblong holes corresponding to the detent rectangular in cross-section, the oblong holes being formed as through-holes in the side parts. The recesses may also have a circular, oval, star-shaped, angular, etc. cross-section. Accordingly, the cross-section of the detent should correspond to the cross-sections of the recesses to safeguard form fit and/or force fit upon engagement in the respective protective position. Furthermore, the recesses can be appropriate indentations or bulges, in which the detent can engage at least partly by form fit and/or force fit, instead of through-holes in the side parts of the base member. As an alternative, it is also possible that the detent, e.g. the spring-loaded bolt, forms a frictional connection to the external surface of the side part without separate recesses being provided in the side part so that the respective protective position can be held.

The detent preferably can also be in the form of a biased bolt e.g. loaded by a spring which is adapted to engage, i.e. to lock in the corresponding recesses of the side parts in the respective protective positions including the home position.

Further, preferentially also more than one detent can be formed at the respective leg portion to provide the engagement with the recesses in the appropriate protective position at several positions of the side parts so that the forces of engagement can be spread over a corresponding area at the side parts and leg portions.

The side part of the base member are preferentially opposed to each other and interconnected by the front-face protective wall which includes a bottle-top shaped recess through which the end piece of the shaft (power take-off shaft end) passes when the base member is mounted at the tractor.

The recess in the base member can also have a rectangular, square, circular or any other cross-sectional shape in order to provide a recess in the protective wall necessary for the power take-off shaft end to pass through.

The afore-described configuration of the protection device according to the invention enables various protective positions to be obtained by simply pivoting the cover part with respect to the base member mounted at the tractor, whereby a high degree of freedom of unfastening of the counter-shaft (power take-off shaft of the mounted implement) with respect to the power take-off shaft end and easy accessibility to the power take-off shaft are ensured and, at the same time, still sufficient protection against the rotating power take-off shaft and/or the power take-off shaft end is given.

In a preferred embodiment, the base member of the protection device is fixed to the front and/or the rear of the tractor (front and/or rear portion) at the tractor body by means of a screwed connection. In particular the base member is screwed to the tractor body in the front and/or rear portion by screws disposed through appropriate holes or material recesses in the front-face protective wall of the base member facing the tractor. The arrangement of the hole pattern and/or the arrangement of the material recesses and the number thereof are dependent on the corresponding threaded holes provided in the tractor body.

The holes can be in the form of vertical and/or horizontal slits in the protective wall of the base member so that a vertical and/or horizontal position of the base member of the protection device can be adjusted at the tractor body.

Alternatively, the protection device can also be mounted to the tractor body through the base member by an appropriate hook, detent, snap mechanism, etc.

Preferentially, at its two leg portions the cover part includes reinforcing ribs which, for instance, extend obliquely or cross-shaped laterally outside at the leg portions. Moreover, the cover part includes reinforcing ribs at a transition from the leg portion to the top plate which connects the two leg portions and is arranged at right angles to the latter, and the base member equally includes reinforcing ribs at a transition from the side parts to the protective wall. The respective reinforcing ribs are intended to increase the strength, tread load and flexural strength of the protection device so that the same strength values can be obtained as in the case of a metallic protection device; it can especially be achieved that an operating person can stand on the protection device without the safety regulations concerning tread safety of the protection device according to the suitable standards being limited.

The leg portions are preferentially flexible in such a way that by bending the leg portions the abutting contact between the stop and the base member is released so that the cover part can be further pivoted toward the base member. Alternatively, the stop can be biased by spring load such that the spring-loaded stop projects from the leg portion so that the cover part is in contact with the base member in an abutting position and the stop is urged against the spring force into the leg portion so as to release the abutting contact between the stop and the base member when the cover part is further pivoted toward the base member.

In a preferred configuration, the pivot axis can be made of a rigid material such as plastic or metallic material.

The preferred application of the protection device according to the invention relates to a work machine, especially a tractor, so that said shaft is the power take-off shaft (power take-off shaft end) of the tractor at the front and/or rear portion thereof.

### BRIEF DESCRIPTION OF THE DRAWINGS

Preferred embodiments of the invention will be described hereinafter in detail with respect to the drawings in which

FIG. 1 shows a side-face view of a protection device in accordance with a first embodiment of the invention;

FIG. 2 shows another side-face view of the protection device in accordance with the first embodiment of the invention of FIG. 1;

FIG. 3 shows a U-shaped cover part of the protection device according to the first embodiment of the invention in a side-face view;

FIG. 4 shows a view from the bottom of the cover part of the protection device according to the first embodiment of the invention;

FIG. 5 shows a base member to which the cover part is pivoted and which is adapted to be mounted at the machine body (not shown) for the protection device according to the first embodiment of the invention; and

FIG. 6 shows a pivot axis supported between the cover part and the base member, as shown in FIG. 1, so as to pivot the cover part to the base member of the protection device according to the first embodiment of the invention.

FIG. 7 is a side-face view of a protection device according to a second embodiment of the invention in a home position;

FIG. 8 is a side-face view of the protection device according to the second embodiment of the invention in a first protective position in which the cover part is pivoted away from the base member;

FIGS. 9A and 9B show side-face views of the protection device according to the second embodiment of the invention in a second protective position in which the cover part is pivoted toward the base member.

### DETAILED DESCRIPTION

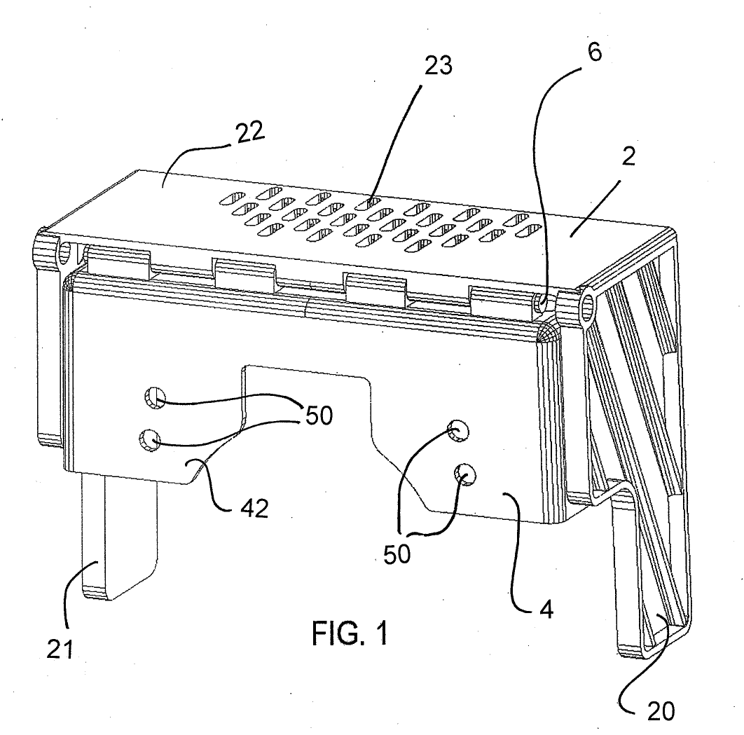

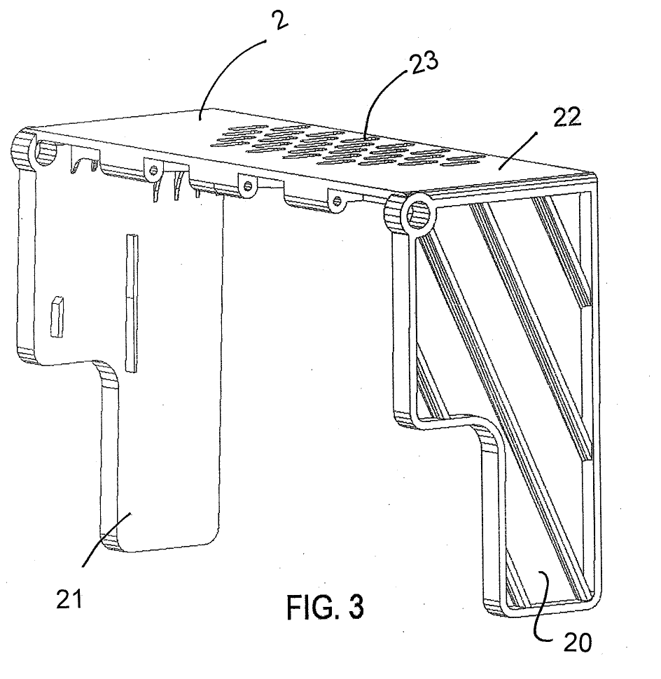

Hereinafter a protection device in accordance with an embodiment of the present invention will be described in detail with reference to the afore-mentioned FIGS. 1 to 6.

The protection device substantially comprises a cover part 2 (cover), a base member 4 and a pivot axis 6, as illustrated in FIG. 1. The cover part 2, the base member 4 and the pivot axis 6 are made of plastic material so as to ensure a minimum total weight of the protection device.

A power take-off shaft end (not shown) of a work machine, e.g. a tractor, is protected from the side and from the top by the protection device, especially by the cover part 2. The power take-off shaft end (power take-off shaft or end piece of a shaft) is connected to an engine gear train (not shown) of the tractor. The power take-off shaft end of the tractor can be arranged at the front and/or rear portion of the tractor. Correspondingly, the protection device is fixed at the front and/or the rear of the tractor in a usual way, for instance by attaching the base member 4 to the tractor body by means of a screwed connection (not shown). In particular screws (not shown) passing through holes 50 in a front-face protective wall 42 of the base member 4 and being screwed into the tractor body fasten the protection device to the tractor body at a predetermined position. Alternatively, the protection device can be mounted on the tractor body via the base member also by a hook or snap mechanism (not shown). Since the mounting of the protection device at the tractor body is usually known, the detailed description thereof is dispensed with.

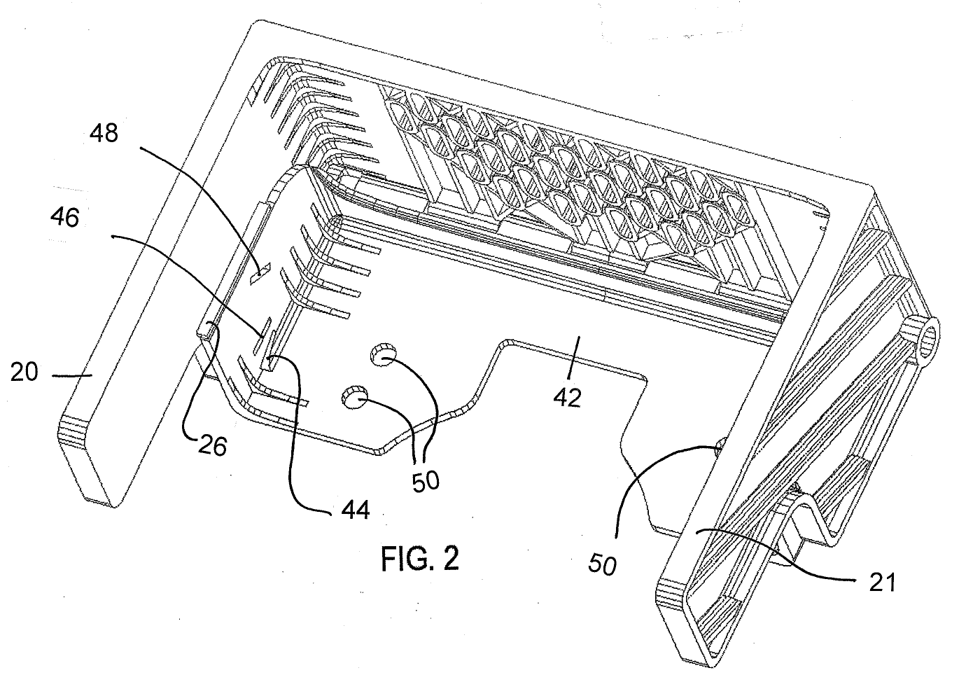

The protection device is illustrated in FIGS. 1 and 2 in a home position protecting the power take-off shaft end, which is not shown, against dirt, grass, trash or the like. Furthermore, the protection device also protects the operating person against injuries which otherwise might be caused during connecting or disconnecting the rotating power take-off shaft. Consequently, it is a substantial feature of the protection device of the present invention to sufficiently protect operating persons against injuries when they work in the area of the power take-off shaft.

The cover part 2 is U-shaped, i.e. it includes two leg portions 20 and 21 which are integrally connected to each other at their upper side by a joint top plate 22. It is also possible, as an alternative, that the cover part 2 is formed of three separate parts (i.e. two side parts and one top member) which are stably interconnected.

In the protection device according to the invention of the shown embodiment the two leg portions 20 and 21 at the left-hand and right-hand end portions of the top plate 22 (namely at the left and at the right in FIG. 1) perpendicularly project downwards at an angle of 90 degrees with respect to the top plate 22. The leg portions 20, 21 moreover include reinforcing ribs to ensure a required flexural strength of the cover part 2. For the rest, the top plate 22 is provided with a plurality of holes 23, as shown in FIG. 1. Said holes 23 enable an operating person to check if the power take-off shaft surrounded by the cover part 2 is in or out of operation, i.e. whether or not it is rotating. Thus, providing the holes 23 permits the operating person to check the operation of the power take-off shaft.

In order to be able to save weight and to permit pivoting of the cover part 2 in the direction of the tractor body, the leg portions 20, 21 are P-shaped. The material recess given due to the P-shape causes a reduction of the weight of the leg portions 20 and 21, i.e. of the entire cover part 2. Furthermore, by reason of said material recess the cover part 2 can be pivoted further in the direction of the tractor body with respect to the base member 4, which will be described hereinafter.

Moreover, the top plate 22 is provided including three receiving portions which are downwards protruding at the end of the top plate 22 facing the tractor and have a through-hole each. Said through-holes receive the pivot axis 6 so that the cover part 2 is pivoting about said axis.

In addition, the cover part 2 includes further reinforcing ribs at its transition regions from the leg portions 20 and 21 to the top plate 22 at the inside of the component and in the area of the receiving portions and holes 23 at the inside of the top plate 22, whereby the strength, especially the flexural strength of the cover part 2 is additionally increased. Thus, it is ensured by the reinforcing ribs at the transition regions, the top plate and the leg portions that the operating person can stand on the cover part 2 without the cover, especially the cover part 2 being excessively deformed. Consequently, a tread safety is given for the protective cover. Usually a tread safety as to a load of 100 kg is sufficient in accordance with the standard requirements of power take-off shaft protection for tractors. By appropriately providing additional and/or strengthened reinforcing ribs at the plastic components even higher load values can be achieved, however.

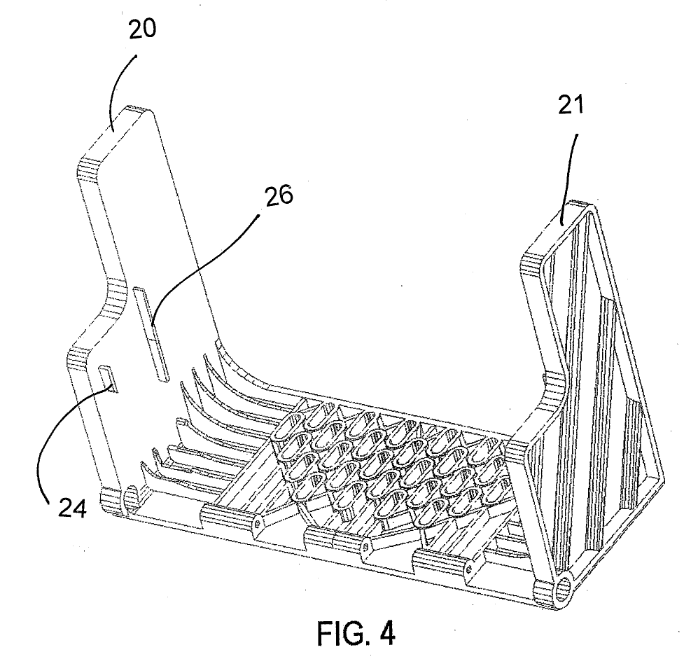

Further, as illustrated in FIG. 2 and FIG. 4, at the inside of each leg portion 20, 21 a detent 24 and a stop 26 are protruding radially inwardly from the inside in the direction of the other leg portion. The functions and modes of action of said detent 24 and the stop 26 will be explained in more detail hereinafter.

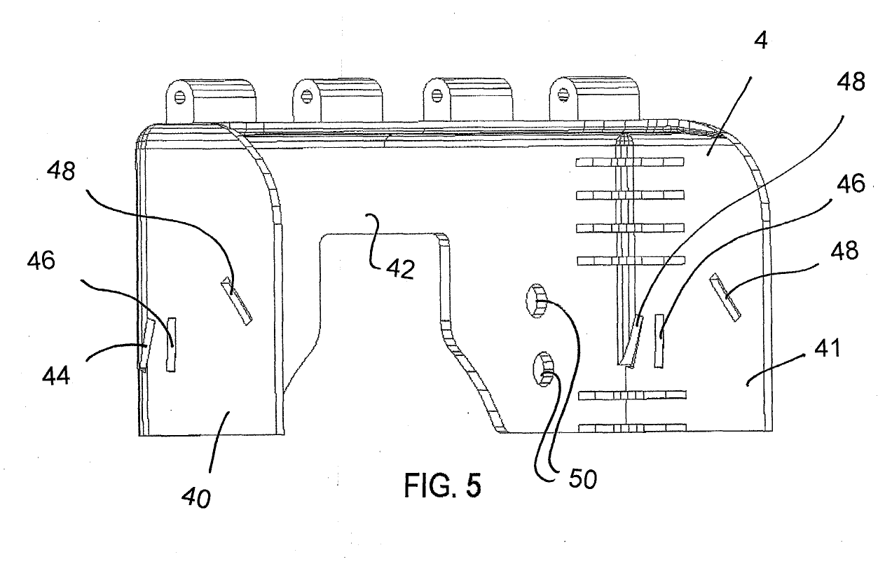

Moreover, in FIG. 1 and especially in FIG. 5, the design of the base member 4 is illustrated in detail. The base member 4 has two parallel side walls (side parts 40, 41) connected at the rear ends thereof, i.e. at the side facing the tractor, by means of a protective wall 42. At the upper side of the protective wall 42 and the side parts 40, 41 a material area disposed at right angles to the protective wall 42 and the side parts 40, 41 is provided from which respective receiving portions (four in the embodiment) of the base member 4 for the pivot axis 6 are upwards projecting. Thus, the cover part 2 is movably received and fastened to the base member 4 by means of the pivot axis 6.

The protective wall 42 further includes a bottle-top shaped recess, which alternatively may also be rectangular, circular, etc., said recess serving for receiving the power take-off shaft end and surrounding the same, respectively. At the right and at the left of said recess two respective holes 50 are provided in this embodiment through which the base member 4 can be fastened at the tractor body by means of screws (not shown).

The arrangement and the number of the holes 50 provided in the protective wall 42 of the base member 4 is solely dependent on the predetermined threaded hole pattern at the tractor body in the front and/or rear portion of the tractor. Consequently, alternatively to the shown embodiment having a total of four holes 50, a great variety of hole pattern arrangements is possible in the protective wall 42.

The side parts 40 and 41 moreover have recesses, e.g. oblong holes 44, 46 and 48. Said oblong holes 44, 46 and 48 serve as receiving or engaging areas for the detent 24 of the cover part 2 in the respective protective positions and the home position of the cover part 2 in respect of the base member 4. Thus, the oblong holes 44, 46 and 48 and the detent 24 form a lock mechanism by which the different protective positions can be adjusted and fixed. In the embodiment three protective positions are defined by the lock mechanism, but also more than three or less than three protective positions can be given by providing corresponding recesses. In accordance with the invention, the recesses can be formed at the leg portions of the cover part and the detent can be formed at the side parts of the base member.

It is further sufficient, according to the invention, to arrange the lock mechanism on at least one leg portion of the cover part and on a corresponding side part of the base member.

As shown in FIG. 1, the detent 24 engages in the oblong hole 46 in the home position of the cover part 4. By bending the leg portions 20, 21, the abutting contact between the stop 26 and the base member 4 and the engagement between the detent 24 and the oblong hole 46 can be released so that the cover part 2 can be pivoted toward the base member 4 (i.e. in the direction of the tractor) or away from the same. That is to say, when releasing the abutting contact and the locking engagement, the cover part 2 can be pivoted to the front or to the rear with respect to the base member 4.

In order to safely prevent the cover part 2 from fully pivoting with respect to the base member 4, if, for instance, an extremely high weight load is applied to the cover part 2 so that the locking engagement is loosened or even released, because the side parts 40, 41 and/or the leg portions 20, 21 are deformed due to the weight load, the cover part 2 is adjacent by its stop 26 to the front end faces of the side parts 40, 41 of the base member 4 in the home position of the protection device in which the protective plate 42 is arranged at right angles to the top plate 22 (cf. e.g. FIGS. 1 and 2).

When the cover part 2 is pivoted away from the base member 4 (from the tractor), the protection device can be pivoted until the oblong hole 48 engages with the detent 24. When the detent 24 gets in locking engagement with (engages in) the hole 48, a first protective position is defined in which the protective wall 42 of the base member 4 and the top plate 22 of the cover part 2 are at obtuse angles. That is to say, in said first protective position the cover component 2 projects obliquely to the front from the base member 4, thereby a greater degree of freedom being given for the fastening of the power take-off shaft to the power take-off shaft end and, simultaneously, better access being ensured for the operating person to the power take-off shaft fastening while sufficient protection is guaranteed by the protection device.

Furthermore, the cover part 2 can be pivoted with respect to the base member 4 also to the rear, i.e. in the direction of the tractor. To this effect, again force is applied from the inside to the outside by the operating person to the right and/or left leg portion of the cover part 2 so as to release the engagement between the detent 24 and the oblong hole 46. At the same time, such force has to be applied to resiliently deform the leg portions 20, 21 so that they can be guided past the stop 26 to the rear. The portions are pivoted to the rear until the oblong hole 44 engages (locks) with the detent 24. In said second protective position the cover part 2 faces the tractor, i.e. the protective wall 42 and the top plate 22 are at acute angles with respect to each other, whereby a greater degree of freedom results for a top link of the tractor.

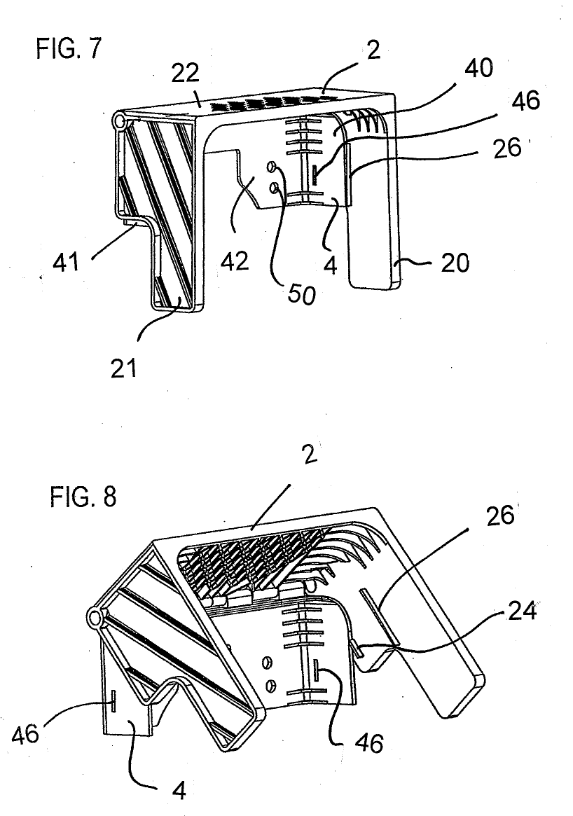

Another configuration of the protection device in accordance with a second embodiment of the present invention is described hereinafter with reference to FIGS. 7 to 9B. Equal or corresponding parts in the second embodiment are denoted with the same reference numerals as in the first embodiment. In the following, only the differences from the first embodiment are described.

In the second embodiment each of the side parts 40 and 41 of the base member 4 has only one recess, namely the oblong hole 46 for the home position of the protection device. As shown in FIG. 7, the respective detent 24 engages in the oblong hole 46 at the leg portion 20, 21 in the home position of the cover part 2 and the front end faces of the side parts 40, 41 of the base member 4 are in abutting contact with the respective stop 26.

By bending the leg portions 20, 21 the abutting contact between the stop 26 and the base member 4 and the engagement between the detent 24 and the oblong hole 46 are released so that the cover part 2 can be pivoted in the direction of the base member 4 (i.e. toward the tractor) or away from the same.

When the cover part 2 is pivoted away from the base member 4 (from the tractor) into the first protective position, the cover part 2 of the protection device is pivoted until the detent 24 abuts against the front end face of the side part 20, 21 of the base member 4 (cf. FIG. 8). Thus the position of the cover part 2 with respect to the base member 4 is determined and clearly defined by said abutting contact between the detent 24 serving as a second stop in the first protective position and the side part 20, 21. In particular, in order to ensure a sufficient abutting contact between the detent 24 and the respective side part 20, 21 in the first protective position, the detent 24 can have an inclined surface at its upper area, whereby the stop surface of the detent 24 is increased.

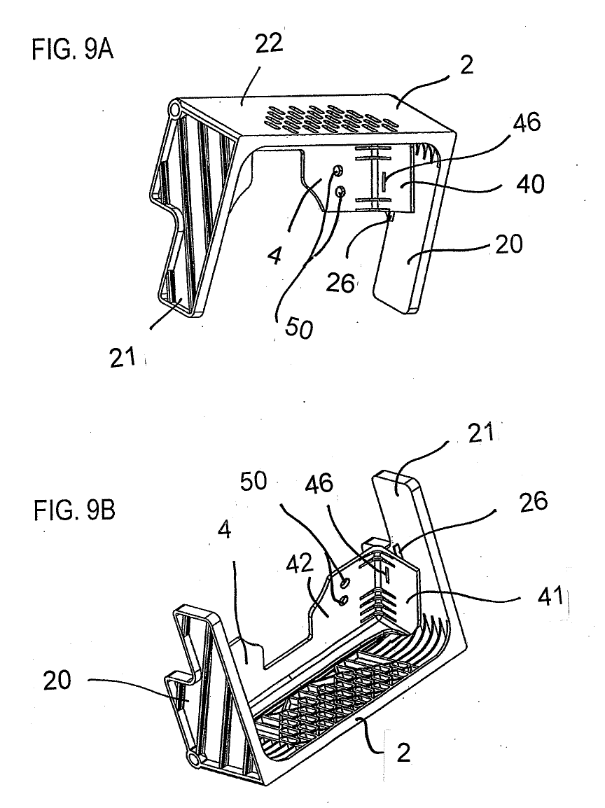

Further, the cover part 21 can also be pivoted to the rear, i.e. in the direction of the tractor. To this effect, again the operating person applies a force from the inside to the outside to the right or left leg portion of the cover part 2 so as to release the engagement between the detent 24 and the oblong hole 46 and to resiliently deform the leg portions 20, 21 such that they can be guided past the stop 26 to the rear and about the pivot axis 6 into the second protective position (cf. FIGS. 9A and 9B). The location of the second protective position is determined by the fact that the front end face of the side part 20, 21 abuts against a reinforcing rib at the transition area between the leg portions 20, 21 and the top plate 22 and by the frictional contact of the stop 26 at the respective external surface of the side part 20, 21 (cf. FIG. 9B).

Moreover, for instance, in the first embodiment, though not shown in the figures, the right-hand and left-hand leg portions 40, 41 can be formed to have a material indentation (inward bulge) or a material recess between the oblong hole 46 and the oblong hole 48 so as to provide pivoting of the cover part 2 toward the tractor and simultaneously a receiving area for the stop 26 without the leg portions 40, 41 being excessively forced outwardly due to the presence of the stop 26 so that the second protective position can be safely held by the lock engagement between the detent 24 and the oblong hole 44.

Alternatively, the respective stops can also be spring-loaded stops so that the spring-loaded stops protrude from the leg portions when the cover part abuts against the base member. When the cover part is to be pivoted e.g. to the rear, namely past the stop, the stop can be urged against the spring force into the leg portion so as to release the contact between the stop and the base member so that the cover part is pivoted in the direction of the tractor into the second protective position without corresponding material bulges or recesses in the side parts being required for receiving stationary stops.

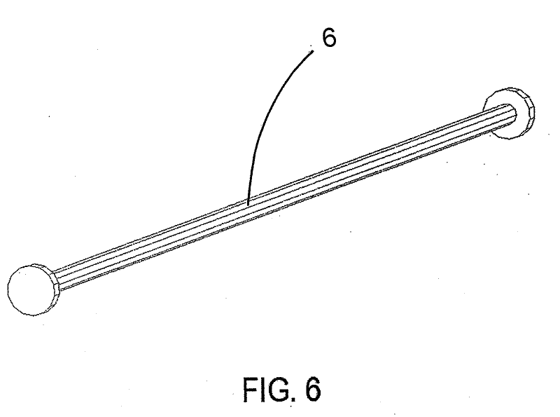

For the rest, in FIG. 6 the pivot axis 6 is shown as a cylindrical component. Said cylindrical component is plate-shaped at its ends. Said component is usually made of plastic material, but is may also be a metallic component.

When manufacturing the protection device according to the embodiment, the pivot axis 6 is supported in bearings and then the base member 4 is injection-molded with the four receiving portions around the pivot axis 6 by an injection-molding process.

After that, the finished base member 4 can be forwarded along with the pivot axis 6 to another injection-molding machine, where the cover part 2 is injection-molded by means of the injection-molding process around the remaining open cylindrical positions of the pivot axis 6 at which the receiving portions of the base member 4 are not formed and around the base member 4. Thus, the protection device is formed as a quasi-integral component during an injection-molding process by the base member 4, the pivot axis 6 and the cover part 2.

Alternatively, the cover member 2 can also be manufactured by the same injection-molding machine as the base member 4 without another injection-molding machine being employed.

The protection device can alternatively also be assembled of three separately manufactured components instead of quasi-integrally by means of injection-molding.

As a matter of fact, the afore-described embodiments only serve for the purpose of illustration and do not restrict the invention. The present invention can be applied also in numerous further ways resulting to the person skilled in the art from the scope of protection of the enclosed claims.

1. A protection device, in particular power take-off shaft protection, for an end piece of a shaft, comprising an integrally formed U-shaped cover which is pivotally mounted to a base member and is pivoting about a pivot axis from a home position into various protective positions, wherein both the cover and the base member are made of plastic material and the U-shaped cover includes reinforcing ribs at its two leg portions to increase the tread load and the flexural strength of the cover so that the protection device constitutes a tread.

2. A protection device according to claim 1, wherein the cover is a cover part consisting at least of two leg portions and a top plate interconnecting said leg portions.

3. A protection device according to claim 1 wherein the pivot axis is arranged at right angles with respect to the axis of the shaft.

4. A protection device according to claim 2, wherein the cover part abuts against the base member via a stop at least in the home position, wherein the stop is laterally formed on at least one of the leg portions of the cover part.

5. A protection device according to claim 4, wherein the stop provided at the one leg portion faces the other leg portion of the cover part.

6. A protection device according to claim 4, wherein the stop is formed at both leg portions such that the respective stops are opposed in a corresponding manner.

7. A protection device according to claim 1, wherein the base member includes side parts which are opposed to each other and are interconnected by a front side protective wall.

8. A protection device according to claim 7, wherein a lock mechanism is formed on at least one leg portion and one corresponding side part.

9. A protection device according to claim 8, wherein the lock mechanism is configured such that in the side parts at least one recess is formed which is adapted to engage with a detent projecting laterally inwardly from the leg portions of the cover part so as to determine and hold the appropriate protective positions of the cover part with respect to the base member.

10. A protection device according to claim 9, wherein the recess is formed as an oblong hole in the side parts.

11. A protection device according to claim 7, wherein the protective wall has a bottle-neck-shaped recess through which the end piece of the shaft is allowed to pass.

12. A protection device according to claim 7, wherein the cover part includes reinforcing ribs at a transition area from the leg portion to the top plate interconnecting the two leg portions and being arranged at right angles with respect to the latter, and the base member likewise includes reinforcing ribs at a transition area from the side parts to the protective wall so that the strength and the flexural strength of the parts is increased.

13. A protection device according to claim 4, wherein the leg portions are resilient such that by bending the leg portions the abutting contact between the stop and the base member is released so that the cover part can be pivoted further toward the base member.

14. A protection device according to claim 4, wherein the stop is spring-biased such that the stop is projecting from the leg portion so that the cover part abuts against the base member in a stop position and the stop is urged against the spring force into the leg portion so as to release the abutting contact between the stop and the base member, when the cover part is pivoted further towards the base member.

15. A protection device according to claim 1, wherein the pivot axis is made of plastic or a metallic material.

16. A protection device according to claim 1, wherein the shaft is the power take-off shaft of a work machine, in particular a tractor.
